(19) United States
(12) Patent Application Publication
(10) Pub. No.: US 2007/0002145 A1
(43) Pub. Date: Jan. 4, 2007

(54) Motion vector detecting apparatus and motion vector detecting method

(75) Inventor: Hideaki Furukawa, Tokyo (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: OLYMPUS CORPORATION, Tokyo (JP)

(21) Appl. No.: 11/474,442

(22) Filed: Jun. 26, 2006

(30) Foreign Application Priority Data
Jun. 29, 2005 (JP) 2005-190014

(51) Int. Cl. H04N 5/225

(52) U.S. Cl. 348/207.99

(57) ABSTRACT

A motion vector detecting apparatus includes a block setting unit, and a correlation operation unit. The block setting unit may be adapted to set a block on a first image. The first image has a distortion caused by an optical system. The block has a size that depends on the distortion. The correlation operation unit may be adapted to calculate a correlation between the block and a second image. The second image differs in capturing-time from the first image. The correlation operation unit may also be adapted to obtain a first motion vector associated with the block with reference to the correlation.

### BACKGROUND OF THE INVENTION

1. Field of the Invention

The present invention generally relates to a motion detector detecting apparatus and a motion vector detecting method. More specifically, the present invention relates to a motion detector detecting apparatus and a motion vector detecting method, both of which are suitably applicable to electronic image pickup devices such as digital cameras so as to prevent any deterioration of image quality due to camera shake.

Priority is claimed on Japanese Patent Application No. 2005-190014, filed Jun. 29, 2005, the content of which is incorporated herein by reference.

2. Description of the Related Art

All patents, patent applications, patent publications, scientific articles, and the like, which will hereinafter be cited or identified in the present application, will hereby be incorporated by reference in their entirety in order to describe more fully the state of the art to which the present invention pertains.

For digital camera, various proposals have been made for preventing the deterioration of image quality due to camera shake. A typical example of the conventional proposals is to move lenses to perform a camera shake correction. Another typical example of the conventional proposals is to move a CCD (Charge-Coupled Device) to perform the camera shake correction. Still another typical example of the conventional proposals is to store captured images in a plurality of frame memories, so that the stored images of the last and current frames are compared with each other so as to calculate a motion vector, and further that a reading position for reading the image is adjusted to cancel the camera shake electronically. The previous frame means a frame just before the current frame. Electronic-cancelling of the camera shake will hereinafter be referred to as an electronic camera shake correction.

The implementation of the electronic camera shake correction needs a motion vector detection unit that detects the direction and magnitude of displacement of the image relative to the previous frame. The motion vector detection can be made by a block matching. A conventional example of the block matching is disclosed in Japanese Unexamined Patent Application, First Publication, No. 2000-261757. This conventional example of the block matching will be described.

In accordance with the block matching method, images of a plurality of frames, generally the current frame and the previous frame, have been stored in a memory such as an SDRAM (Synchronous Dynamic Random Access Memory). FIG. 13 is a view illustrating a current frame 1100 that includes a current frame evaluation block 1110. FIG. 14 is a view illustrating a previous frame evaluation block 1210 and the current frame evaluation block 1110. The current frame evaluation block 1110 corresponds to a part of the image of the current frame 1100. The current frame evaluation block 1110 is represented by a black square mark shown in FIG. 13. The previous frame evaluation block 1210 corresponds to a part of the image of the previous frame. The previous frame evaluation block 1210 has almost the same position and almost the same size as the current frame evaluation block 1110. The previous frame evaluation block 1210 is represented by a hatched square mark shown in FIG. 14. The current frame evaluation block 1110 is cut from the current frame 1100 as well as the previous frame evaluation block 1210 is cut from the previous frame 1200. A total sum of absolute values of differences of pixels is calculated.

FIG. 15 is a fragmentary enlarged view illustrating a positional relationship between the current frame evaluation block 1110 and the previous frame evaluation block 1210 shown in FIG. 14. The previous frame evaluation block 1210 is represented by a real line. The current frame evaluation block 1110 is represented by a dotted line. An arrow mark represents a vector V that is used to obtain a correlation value between the current frame evaluation block 1110 and the previous frame evaluation block 1210. The previous frame evaluation block 1210 is displaced relative to the current frame evaluation block 1110. The magnitude of one time displacement corresponds to a pixel size. Namely, the previous frame evaluation block 1210 is displaced one pixel size by one pixel size. A correlation value is defined by the total sum of absolute values of differences between pixels. The correlation value is calculated every time when the above-described displacement is made. When the calculated correlation value is minimized, a positional relationship of the images is stored in a memory. The positional relationship is represented by a motion vector.

The motion vector or vectors may be stored in the memory not only when the calculated correlation value is minimized but also when the calculated correlation value is the second, third or n-th minimum value. These processes are applied to all of the evaluation blocks in the frame thereby obtaining motion vectors. The obtained motion vectors are used to calculate the magnitude and direction of a total motion of the image relative to the whole frame. The calculation cam be made by a CPU. A read address is adjusted to cancel the magnitude of the total motion of the image.

FIG. 12 is a block diagram illustrating an example of a configuration of a conventional image processing apparatus that uses a motion vector detecting function as a part of camera shake correction functions. In FIG. 12, a conventional image processing apparatus is configured by a preprocessor 1, a CPU 2, an SDRAM 3, an image processor 4, and a motion vector detecting unit 7. The motion vector detecting unit 7 performs a motion vector detecting function as a part of camera shake correction functions. The motion vector detecting unit 7 is configured by a motion vector detecting control unit 71, a DMA 72, a first memory 73, a correlation operation unit 74, a sorter 75, and a second memory 76. The motion vector detecting control unit 71 is configured by an evaluation block position calculating unit 711, and a DMA parameter calculating unit 712.

An image is captured by a CCD. The captured image is then inputted into the preprocessor 1 to obtain evaluation values for AE (Automatic Exposure), AF (Auto Focus), and AWB (Auto White Balance). The image is then stored in the SDRAM 3. The stored image has a Bayer array image. The image has a distortion.

The CPU 2 refers the evaluation values for AE, AF, and AWB to calculate an exposure value, a focus value, an RGB gain, and a white balance coefficient so that the CPU 2 sets parameters to the image processor 4. The CPU 2 also sets other parameters for other image processes. The CPU 2 sets parameters in the motion vector detecting unit 7 to get the motion vector detecting unit 7 start before the image processor 4 starts.

The sorter 55 supplies a triggering signal S_{T} to the motion vector detecting unit 71. The evaluation block position calculating unit 711 arranges the evaluation blocks in a cubic matrix that is shown in FIG. 13. The DMA parameter calculating unit 712 calculates an address Add of an evaluation block on the SDRAM 3. The DMA parameter calculating unit 712 sets the calculated address Add in the DMA 72. The DMA 72 obtains image data from the SDRAM 3 in accordance with the address Add. The DMA 72 stores the image data in the first memory 73. The first memory has stored the current frame evaluation block and the previous frame evaluation block.

The correlation operation unit 74 calculates a correlation value from data stored in the first memory. The correlation operation unit 74 supplies the correlation value and the motion vector to the sorter 75. The sorter 75 receives motion vectors and correlation values, wherein the motion vectors and the correlation values belong to a single evaluation block. The sorter 75 sorts the motion vectors and the correlation values in order of low to high correlation values. The sorter 75 selects motion vectors as local motion vectors. The selected motion vectors correspond to the lowest to n-th lowest correlation values. The number of the selected motion vectors is n. The sorter 75 stores the local motion vectors in the second memory 76.

The CPU 2 determines whether or not a camera shake has appeared, the determination being made with reference to a most frequently appeared motion vector and a dispersion of the motion vectors that are stored in the second memory 76. The CPU 2 calculates the direction of camera shake in view of the entirety of frame. The CPU 2 sets the parameters for the image processors 4 with reference to the calculated direction of the camera shake. The image processor 4 cuts image data little by little, the image data having been stored on the SDRAM 3 so that the image processor 4 processes the image data based on the parameters. The image processor 4 stores the processed image data in the SDRAM 3 again.

### SUMMARY OF THE INVENTION

In accordance with a first aspect of the present invention, a motion vector detecting apparatus may comprise a block setting unit, and a correlation operation unit. The block setting unit may be adapted to set a block on a first image. The first image has a distortion caused by an optical system. The block has a size that depends on the distortion. The correlation operation unit may be adapted to calculate a correlation between the block and a second image. The second image differs in capturing-time from the first image. The correlation operation unit may also be adapted to obtain a first motion vector associated with the block with reference to the correlation.

Preferably, the block setting unit may be adapted to set the block so that the size of the block is generally uniform after the distortion is corrected.

Preferably, the block setting unit may be adapted to set the block at a position selected from a group of positions that have a generally uniform degree of distortion.

Preferably, the motion vector detecting apparatus may further comprise a parameter calculating unit, and a detecting unit. The parameter calculating unit may be adapted to calculate at least one parameter for the block. The at least one parameter is selected from a distance between the block and an optical center of the optical system, coordinates of the block, and a weighting factor of the block. The detecting unit may be adapted to detect a second motion vector associated with an entirety of the first image. The detection is performed with reference to the first motion vector and the at least one parameter.

In one case, the optical system may comprise a co-axial optical system. In another case, the optical system may comprise a decentered optical system.

In accordance with a second aspect of the present invention, a motion vector detecting method may comprise setting a block on a first image, calculating a correlation between the block and a second image, and obtaining a first motion vector associated with the block with reference to the correlation. The first image has a distortion caused by an optical system. The block has a size that depends on the distortion. The second image differs in capturing-time from the first image.

Preferably, the block may be set so that the size of the block is generally uniform after the distortion is corrected.

Preferably, the block may be set at a position on the first image. The position has a generally uniform degree of distortion.

Preferably, the motion vector detecting method may further comprise calculating at least one parameter for the block, and detecting a second motion vector associated with an entirety of the first image. The at least one parameter is selected from a distance between the block and an optical center of the optical system, coordinates of the block, and a weighting factor of the block. The detection is performed with reference to the first motion vector and the at least one parameter.

These and other objects, features, aspects, and advantages of the present invention will become apparent to those skilled in the art from the following detailed descriptions taken in conjunction with the accompanying drawings, illustrating the embodiments of the present invention.

### BRIEF DESCRIPTION OF THE DRAWINGS

Referring now to the attached drawings which form a part of this original disclosure:

FIG. 1 is a block diagram illustrating an example of a configuration of a motion vector detecting apparatus in accordance with the first embodiment of the present invention;

FIG. 2 is a view illustrating an array of evaluation blocks in accordance with the first embodiment of the present invention;

FIG. 3 is a view illustrating a size of an evaluation block, wherein a distortion correction has not yet been made, in accordance with the first embodiment of the present invention;

FIG. 4 is a view illustrating a size of an evaluation block, wherein a distortion correction has already been made, in accordance with the first embodiment of the present invention;

FIG. 5 is a flow chart illustrating a process flow of the motion vector detecting apparatus shown in FIG. 1;

FIG. 6 is a block diagram illustrating an example of a configuration of a motion vector detecting apparatus in accordance with the second embodiment of the present invention;

FIG. 7 is a view illustrating an array of evaluation blocks in accordance with the second embodiment of the present invention;

FIG. 8 is a view illustrating a size of an evaluation block, wherein a distortion correction has not yet been made, in accordance with the second embodiment of the present invention;

FIG. 9 is a view illustrating a size of an evaluation block, wherein a distortion correction has already been made, in accordance with the second embodiment of the present invention;

FIG. 10 is a perspective view illustrating a set of cylindrical lenses to be used as an optical system that corrects a concentric distortion;

FIG. 11 is a view illustrating an array of evaluation blocks of a uniform size, the array of evaluation blocks being captured by an optical system that has a concentric distortion;

FIG. 12 is a block diagram illustrating an example of a configuration of a conventional image processing apparatus that uses a motion vector detecting function as a part of camera shake correction functions;

FIG. 13 is a view illustrating a current frame that includes a current frame evaluation block;

FIG. 14 is a view illustrating a previous frame evaluation block and the current frame evaluation block; and

FIG. 15 is a fragmentary enlarged view illustrating a positional relationship between the current frame evaluation block and the previous frame evaluation block shown in FIG. 14.

### DETAILED DESCRIPTION OF THE INVENTION

Selected embodiments of the present invention will now be described with reference to the drawings. It will be apparent to those skilled in the art from this disclosure that the following descriptions of the embodiments of the present invention are provided for illustration only and not for the purpose of limiting the invention as defined by the appended claims and their equivalents.

### First Embodiment

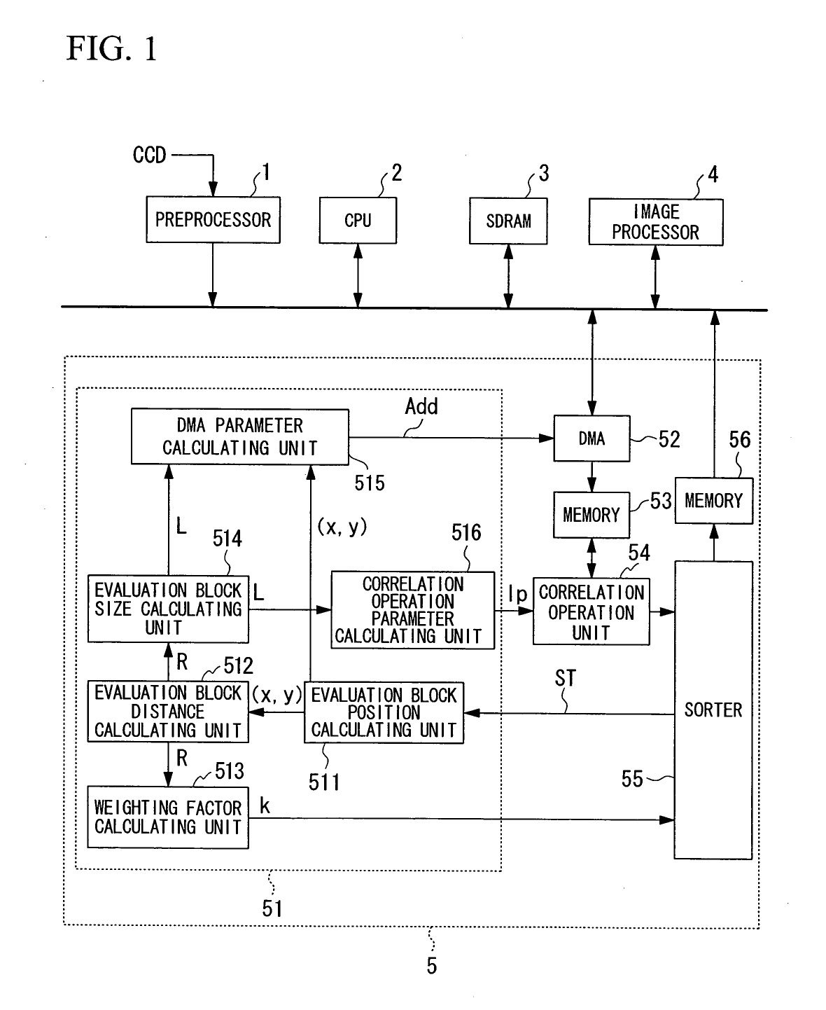

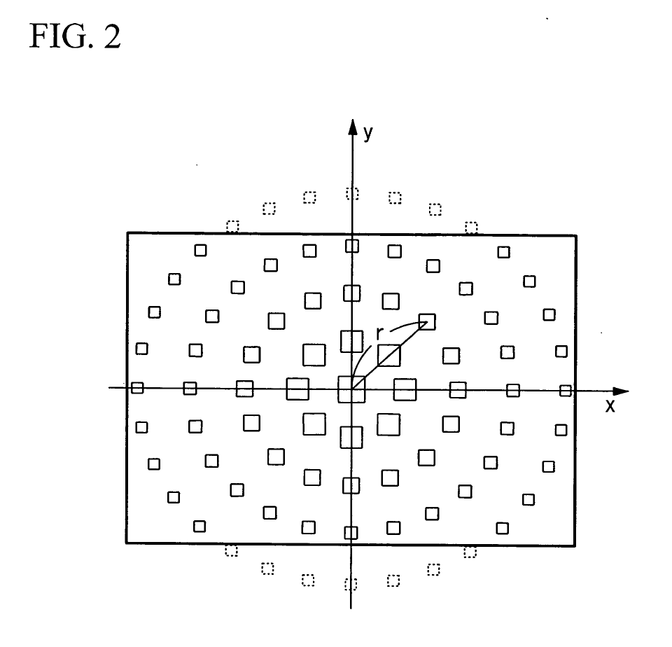

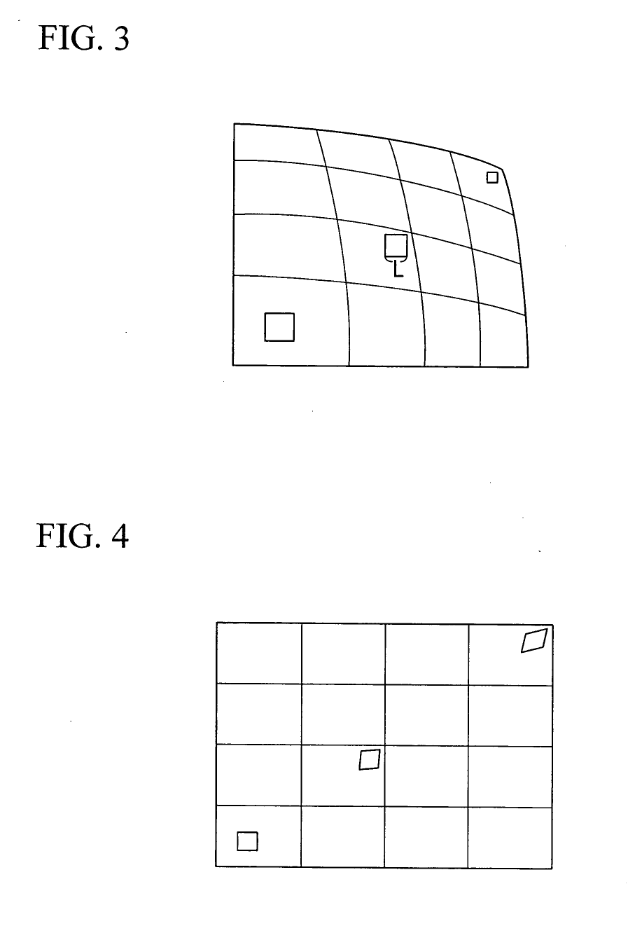

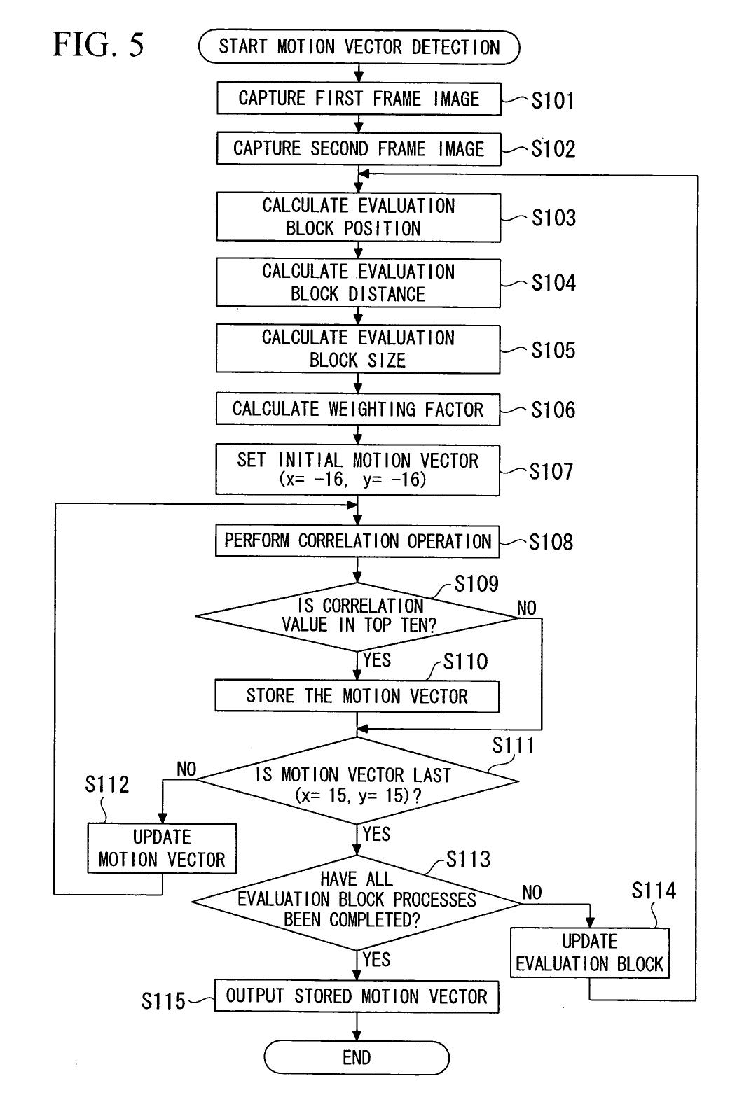

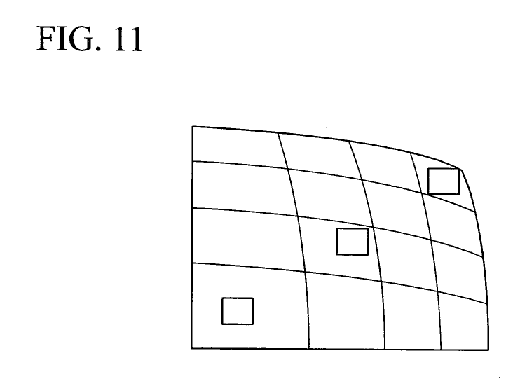

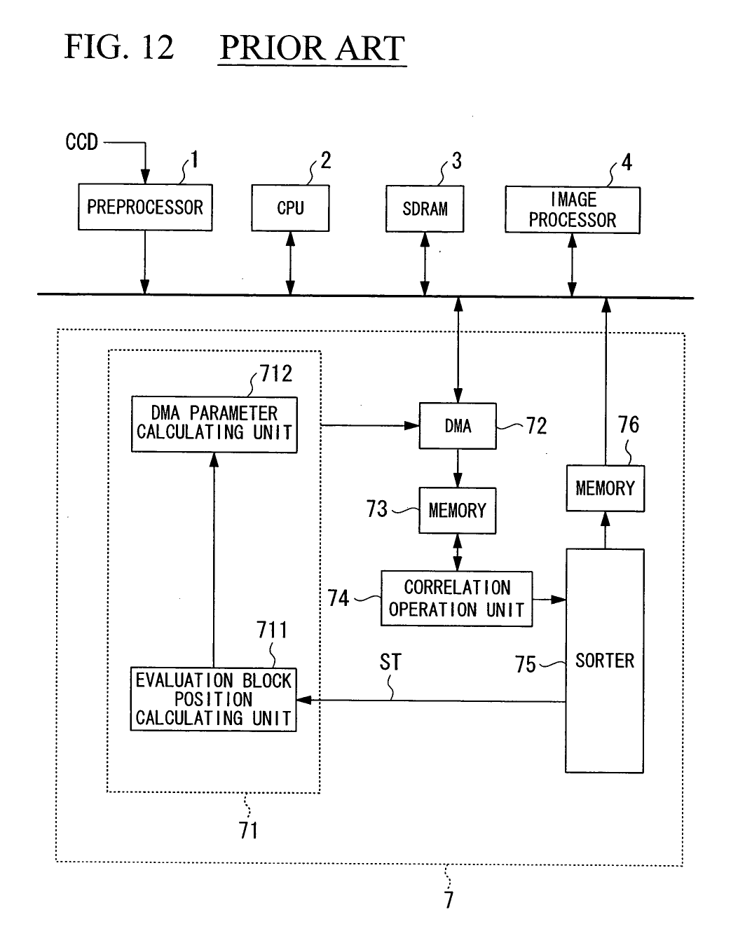

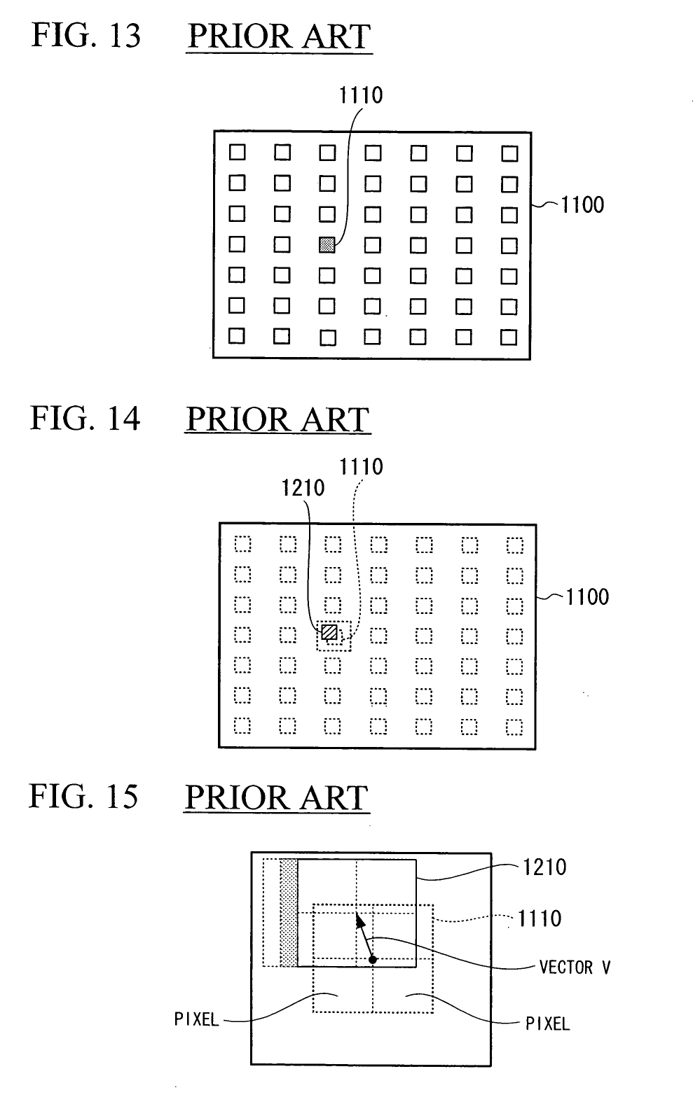

A first embodiment of the present invention will be described with reference to the drawings. FIG. 11 is a view illustrating an array of evaluation blocks of a uniform size, the array of evaluation blocks being captured by an optical system that has a concentric distortion. In accordance with the first embodiment of the present invention, a motion vector detecting apparatus is provided, which is suitable for digital cameras having an optical system with a concentric distortion as shown in FIG. 11. The optical system may be configured by a co-axial optical system. FIG. 1 is a block diagram illustrating an example of a configuration of a motion vector detecting apparatus in accordance with the first embodiment of the present invention. FIG. 2 is a view illustrating an array of evaluation blocks in accordance with the first embodiment of the present invention. FIG. 3 is a view illustrating a size of an evaluation block, wherein a distortion correction has not yet been made, in accordance with the first embodiment of the present invention. FIG. 4 is a view illustrating a size of an evaluation block, wherein a distortion correction has already been made, in accordance with the first embodiment of the present invention. FIG. 5 is a flow chart illustrating a process flow of the motion vector detecting apparatus shown in FIG. 1.

As shown in FIG. 1, the motion vector detecting unit may include, but is not limited to, a preprocessor 1, a CPU 2, an SDRAM 3, an image processor 4, and a motion vector detecting unit 5. The motion vector detecting unit 5 may include, but is not limited to, a motion vector detecting control unit 51, a DMA 52, a first memory 53, a second memory 56, a correlation operation unit 54, and a sorter 55. The motion vector detecting control unit 51 may include, but is not limited to, an evaluation block position calculating unit 511, an evaluation block distance calculating unit 512, a weighting factor calculating unit 513, an evaluation block size calculating unit 514, a DMA parameter calculating unit 515, and a correlation operation parameter calculating unit 516. The evaluation block position calculating unit 511 also performs as a part of a block setting unit. The evaluation block distance calculating unit 512 also performs as a part of a parameter calculating unit. The weighting factor calculating unit 513 also performs as a part of the parameter calculating unit. The evaluation block size calculating unit 514 also performs as a part of the block setting unit.

Main functions of the preprocessor 1, the CPU2, the SDRAM 3, the image processor 4, the DMA 52, the first memory 53, and the correlation operation unit 54 are the same as those described above. Duplicate descriptions of the main functions will be omitted accordingly.

The evaluation block position calculating unit 511 can be configured to calculate a position of each evaluation block. For example, as shown in FIG. 2, the evaluation block position calculating unit 511 calculates positions of the evaluation blocks that are arranged concentrically with reference to an optical center. The optical center is defined by a crossing point of an X-axis and a Y-axis. The position of the evaluation block may be represented by a coordinate position (X, Y) on the two dimensional coordinate system. The evaluation block position calculating unit 511 can be configured to supply the calculated position (X, Y) of the evaluation block to both the evaluation block distance calculating unit 512 and the DMA parameter calculating unit 515.

The evaluation block distance calculating unit 512 can be configured to receive the calculated position of the evaluation block from the evaluation block position calculating unit 511. The evaluation block distance calculating unit 512 can be configured to calculate a distance between each evaluation block and the optical center. The optical center is defined by a crossing point of the X-axis and the Y-axis shown in FIG. 2. A two dimensional coordinate system is set so that the optical center is positioned at the origin of the two dimensional coordinate system. The evaluation block is positioned at a coordinate position (X, Y) of the coordinate system. A distance “r” of the coordinate position (X, Y) from the origin is given by r=(X²+Y²)^{0.5}. In order to reduce a circuit scale, calculating r² is also available. The evaluation block distance calculating unit 512 can be configured to supply the calculated distance to both the weighting factor calculating unit 513 and the evaluation block size calculating unit 514.

The weighting factor calculating unit 513 can be configured to receive, from the evaluation block distance calculating unit 512, the calculated distance between the evaluation block and the optical center. The calculated distance may, for example, be R=r². The weighting factor calculating unit 513 can be configured to calculate a weighting factor k for each evaluation block, the calculation being carried out based on the calculated distance between the evaluation block and the optical center. The weighting factor k indicates the degree of importance of each motion vector that is obtained from the evaluation block. The weighting factor k is set in a range from 0 to 1. The weighting factor k is high as the calculated distance is short. The weighting factor k is low as the calculated distance is long. In other words, the weighting factor k increases as the position comes close to the center of the image, while the weighting factor k decreases as the position comes close to the periphery of the image. The weighting factor calculating unit 513 can be configured to supply the calculated weighting factor k to the sorter 55.

The evaluation block size calculating unit 514 can be configured to receive, from the evaluation block distance calculating unit 512, the calculated distance between the evaluation block and the optical center. The evaluation block size calculating unit 514 can be configured to calculate a size of each evaluation block so that evaluation blocks have a uniform size after a distortion of the image has been corrected. The evaluation block size calculating unit 514 calculates the size L of each evaluation block based on the distance of the evaluation block from the optical center. For example, three selected evaluation blocks on a distortion-containing image are different in size from each other as shown in FIG. 3. The three selected evaluation blocks on a distortion-corrected image are uniform in size as shown in FIG. 4. The evaluation block size calculating unit 514 can be configured to supply the calculated size L to both the DMA parameter calculating unit 515 and the correlation operation parameter calculating unit 516.

The DMA parameter calculating unit 515 can be configured to receive the evaluation block size L from the evaluation block size calculating unit 514. The DMA parameter calculating unit 515 is also configured to receive the evaluation block position (X, Y) from the evaluation block position calculating unit 511. The DMA parameter calculating unit 515 is further configured to calculate an address Add on the SDRAM 3, the address Add corresponding to the evaluation block position (X, Y). The calculation of the address Add is carried out with reference to the evaluation block size L and the evaluation block position (X, Y). The DMA parameter calculating unit 515 is further configured to set the calculated address Add in the DMA 52.

The correlation operation parameter calculating unit 516 can be configured to receive the evaluation block size L from the evaluation block size calculating unit 514. The correlation operation parameter calculating unit 516 can be configured to calculate an operation parameter Ip with reference to a variation in size L of the evaluation blocks. The operation parameter Ip indicates how many times the correlation operation should be performed. The correlation operation parameter calculating unit 516 can be configured to set the calculated correlation value Ip in the correlation operation unit 54.

The sorter 55 is configured to receive a correlation value and the motion vector from the correlation operation unit 54. The sorter 55 is configured to receive the weighting factor k from the weighting factor calculating unit 513. The sorter 55 sorts the correlation value, the motion vector, and the weighting factor k and stores them in the second memory 56. The second memory 56 stores the correlation value, the motion vector and the weighting factor at predetermined addresses, the motion vector and the weighting factor having been outputted from the sorter 55. The CPU 2 performs the camera shake correction with reference to the motion vector and the weighting factor k and by using a coefficient related to the appearance frequency.

A motion vector detecting method in accordance with the first embodiment of the present invention will be described with reference to FIG. 5.

In Step S101, the motion vector detecting unit 5 captures a first frame image as the current frame. The motion vector detecting unit 5 stores the first frame image in the first memory 53.

In Step S102, the motion vector detecting unit 5 also captures a second frame image as the current frame.

In Step S103, the sorter 55 sends a triggering signal S_{T} to the motion vector detecting control unit 51 so that the evaluation block position calculating unit 511 receives the triggering signal S_{T}. Upon receipt of the triggering signal, the evaluation block position calculating unit 511 calculates coordinate positions of the evaluation blocks so that the evaluation blocks are concentrically arranged relative to the optical center. The evaluation block position calculating unit 511 supplies the calculated coordinate positions (X, Y) to the evaluation block distance calculating unit 512 and the DMA parameter calculating unit 515.

In Step S104, the evaluation block distance calculating unit 512 receives the calculated coordinate positions (X, Y) of the evaluation blocks from the evaluation block position calculating unit 511. The evaluation block distance calculating unit 512 calculates the distance R=r² of each evaluation block from the optical center.

In Step S105, the evaluation block distance calculating unit 512 supplies the distance R to the evaluation block size calculating unit 514. The evaluation block size calculating unit 514 calculates the sizes L of evaluation blocks on the distortion-containing image so that the evaluation blocks on the distortion-corrected image have a uniform size. The evaluation block size calculating unit 514 sends the sizes L to the DMA parameter calculating unit 515.

In Step S106, the evaluation block distance calculating unit 512 supplies the distance R to the weighting factor calculating unit 513. The weighting factor calculating unit 513 calculates the weighting factor k for each evaluation block. The weighting factor k indicates the degree of importance of each motion vector that is obtained from the evaluation block.

In Step S107, the correlation operation unit 54 sets an initial motion vector. For example, the correlation operation unit 54 sets a motion vector (X=−16, Y=−16) as the initial value for a left top block shown in FIG. 15.

In Step S108, the correlation operation unit 54 performs a correlation operation based on the initial motion vector that has been set in the previous step. The correlation operation unit 54 supplies a result of the correlation operation to the sorter 55.

In Step S109, if ten results of the correlation operation have been stored in the second memory 56, then the sorter 55 compares a currently obtained correlation operation result to stored correlation operation results. The currently obtained correlation operation result is being obtained from the correlation operation unit 54. The stored correlation operation results are stored in the second memory 56.

In Step S110, if a correlation value as the currently obtained correlation operation result is lower than any of correlation values as the stored correlation operation results, then the least significant correlation value is deleted and in place the correlation value as the currently obtained correlation operation result is stored.

In Step S111, it is verified whether or not, for a single evaluation block, the correlation operation has been completed up to a predetermined last motion vector (X=15, Y=15), for example. If the correlation operation has not yet been completed up to the last motion vector, the process flow will enter into Step S112.

In Step S112, the motion vector is updated by one pixel to perform the correlation operation. The process flow will be returned to Step S108.

In Step S108, the correlation operation unit 54 performs a further correlation operation based on the updated motion vector that has been updated in Step S112. The correlation operation unit 54 supplies a result of the further correlation operation to the sorter 55.

In Step S109, if the correlation value as the currently obtained correlation operation result is higher than all of the correlation values as the stored correlation operation results, then the currently obtained correlation operation result is discard, and the process flow enters into the above described Step S111.

In Step S114, after the processes on any evaluation block in Steps S108-S111 have been completed, the evaluation block is updated. The processes in Steps S103-S111 are then carried out on the updated evaluation block.

In Step S113, if the above processes in Steps S103-S111 have been completed on all of the evaluation blocks, then in Step S115, the motion vector is outputted from the second memory 56. The outputted motion vector is then supplied to the CPU 2, thereby completing the motion vector detecting processes.

Even if the optical system has a concentric distortion, then the evaluation block size is adjusted based on the distance of the evaluation block from the optical center so as to realize a highly accurate correction to the camera shake by using the motion vector.

### Second Embodiment

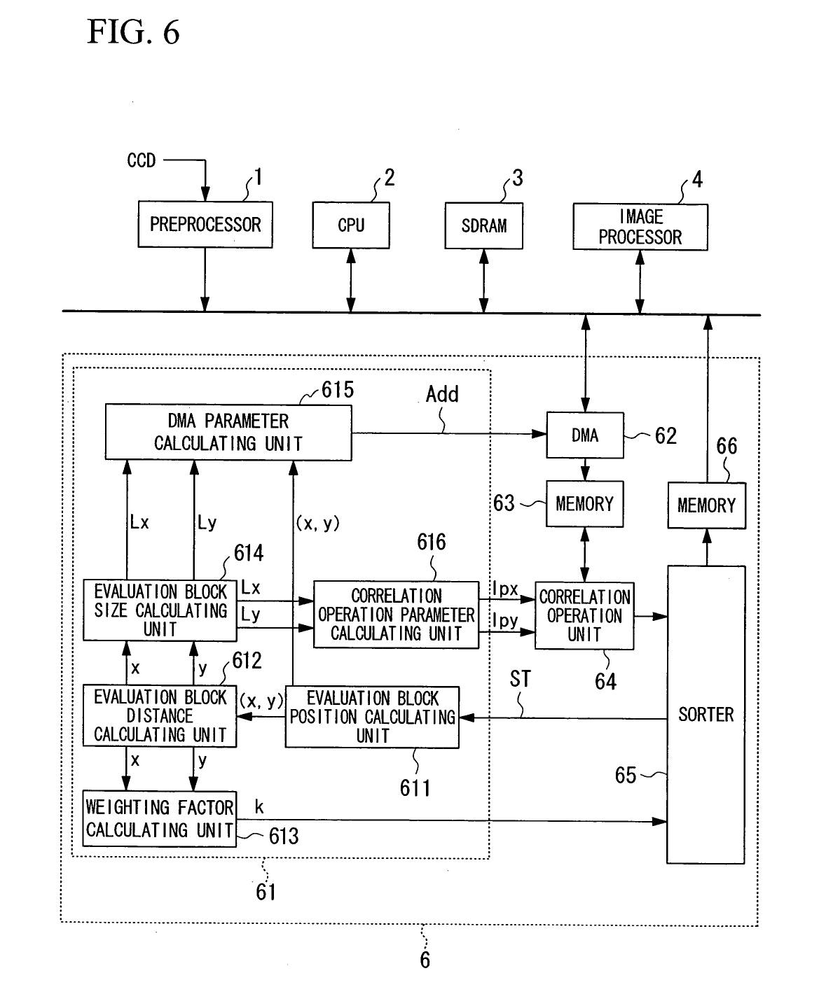

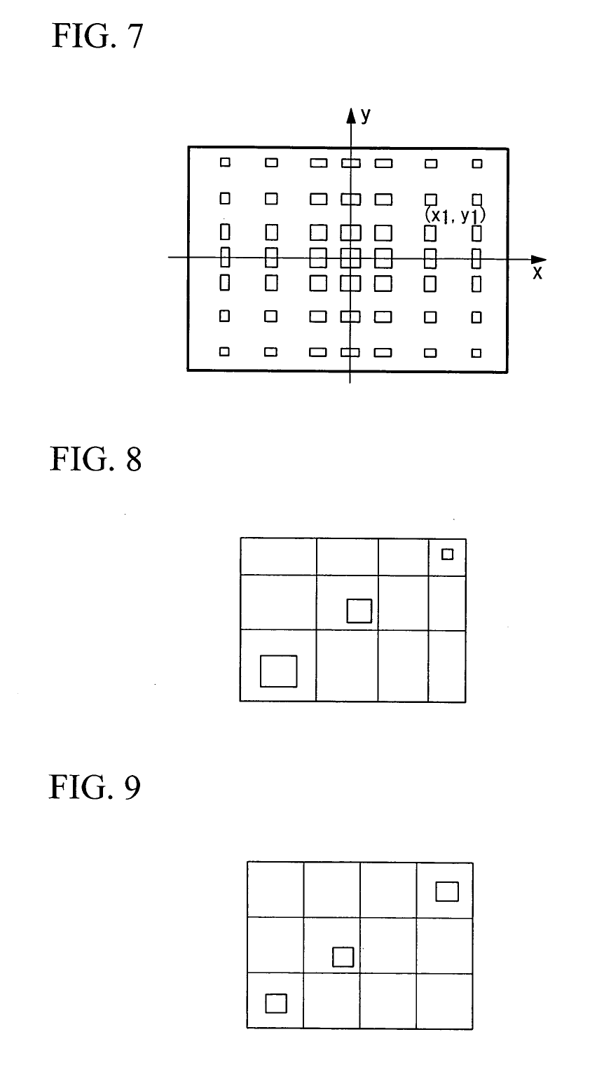

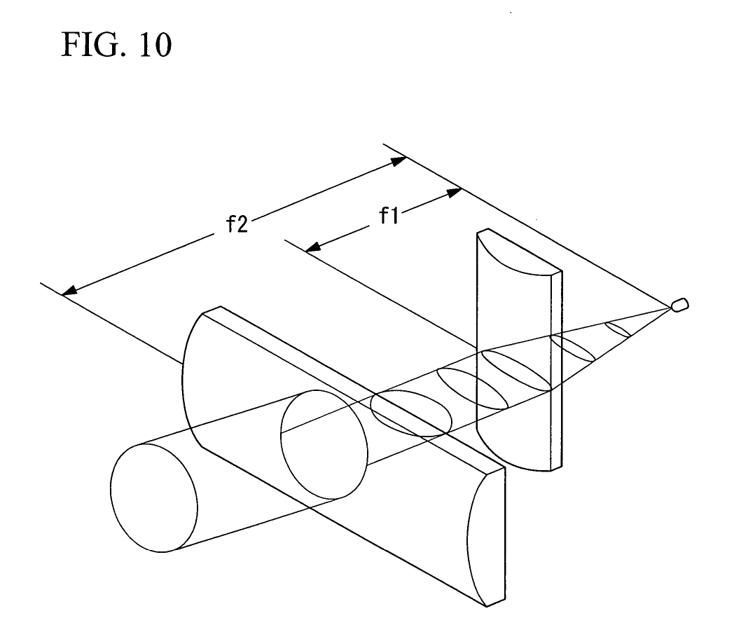

A second embodiment of the present invention will be described with reference to the drawings. FIG. 10 is a perspective view illustrating a set of cylindrical lenses to be used as an optical system that corrects a concentric distortion. In accordance with the second embodiment of the present invention, a motion vector detecting apparatus is provided, which is suitable for digital cameras having an optical system with vertical and horizontal distortions that are independent from each other as shown in FIG. 10. The optical system may be configured by a decentered optical system. FIG. 6 is a block diagram illustrating an example of a configuration of a motion vector detecting apparatus in accordance with the second embodiment of the present invention. FIG. 7 is a view illustrating an array of evaluation blocks in accordance with the second embodiment of the present invention. FIG. 8 is a view illustrating a size of an evaluation block, wherein a distortion correction has not yet been made, in accordance with the second embodiment of the present invention. FIG. 9 is a view illustrating a size of an evaluation block, wherein a distortion correction has already been made, in accordance with the second embodiment of the present invention.

As shown in FIG. 7, the distortion includes a first component in an X-direction and a second component in a Y-direction. It is not necessary to calculate a distance of each evaluation block from the optical center as described in the first embodiment. The X-Y coordinate system can be used directly.

As shown in FIG. 6, the motion vector detecting unit may include, but is not limited to, a preprocessor 1, a CPU 2, an SDRAM 3, an image processor 4, and a motion vector detecting unit 6. The motion vector detecting unit 6 may include, but is not limited to, a motion vector detecting control unit 61, a DMA 62, a first memory 63, a second memory 66, a correlation operation unit 64, and a sorter 65. The motion vector detecting control unit 61 may include, but is not limited to, an evaluation block position calculating unit 611, an evaluation block distance calculating unit 612, a weighting factor calculating unit 613, an evaluation block size calculating unit 614, a DMA parameter calculating unit 615, and a correlation operation parameter calculating unit 616. The evaluation block position calculating unit 611 also performs as a part of a block setting unit. The evaluation block distance calculating unit 612 also performs as a part of a parameter calculating unit. The weighting factor calculating unit 613 also performs as a part of the parameter calculating unit. The evaluation block size calculating unit 614 also performs as a part of the block setting unit.

Main functions of the preprocessor 1, the CPU2, the SDRAM 3, the image processor 4, the DMA 62, the first memory 63, and the correlation operation unit 64 are the same as those described above. Duplicate descriptions of the main functions will be omitted accordingly.

The evaluation block position calculating unit 611 can be configured to calculate a position (X, Y) of each evaluation block. For example, as shown in FIG. 7, the evaluation block position calculating unit 611 calculates positions (X, Y) of the evaluation blocks that are arrayed in a modified matrix.

The evaluation block distance calculating unit 612 can be configured to receive the calculated position (X, Y) of the evaluation block from the evaluation block position calculating unit 611. The evaluation block distance calculating unit 612 can be configured to supply the received position (X, Y) of the evaluation block to both the weighting factor calculating unit 613 and the evaluation block size calculating unit 614.

The weighting factor calculating unit 613 can be configured to receive the position (X, Y) of the evaluation block from the evaluation block distance calculating unit 612. The weighting factor calculating unit 613 can be configured to calculate a product of a first weighting and a second weighting to find a weighting factor k for each evaluation block. The calculation of the product is carried out based on the position (X, Y) of the evaluation block. The first weighting is obtained based on the X-coordinate. The second weighting is obtained based on the Y-coordinate. The weighting factor k indicates the degree of importance of each motion vector that is obtained from the evaluation block. The weighting factor k is set in a range from 0 to 1.

The evaluation block size calculating unit 614 can be configured to receive the position (X, Y) of the evaluation block from the evaluation block distance calculating unit 612. The evaluation block size calculating unit 614 can be configured to calculate first and second sizes (Lx, Ly) of each evaluation block. The first size is defined in the X-direction. The second size is defined in the Y-direction. The calculations of the first and second sizes (Lx, Ly) are performed with reference to the position (X, Y) of the evaluation block. The evaluation block size calculating unit 614 calculates the first and second sizes (Lx, Ly) of each evaluation block with reference to the position (X, Y) of the evaluation block so that evaluation blocks have a uniform size after the distortion of the image has been corrected. For example, three selected evaluation blocks on a distortion-containing image are different in size from each other as shown in FIG. 8. The three selected evaluation blocks on a distortion-corrected image are uniform in size as shown in FIG. 9. The evaluation block size calculating unit 614 can be configured to supply the calculated first and second sizes (Lx, Ly) to both the DMA parameter calculating unit 615 and the correlation operation parameter calculating unit 616.

The DMA parameter calculating unit 615 can be configured to receive the first and second sizes (Lx, Ly) from the evaluation block size calculating unit 614. The DMA parameter calculating unit 615 is also configured to receive the evaluation block position (X, Y) from the evaluation block position calculating unit 611. The DMA parameter calculating unit 615 is further configured to calculate an address Add on the SDRAM 3, the address Add corresponding to the evaluation block position (X, Y). The calculation of the address Add is carried out with reference to the first and second sizes (Lx, Ly) and the evaluation block position (X, Y). The DMA parameter calculating unit 615 is further configured to set the calculated address Add in the DMA 62.

The correlation operation parameter calculating unit 616 can be configured to receive the first and second sizes (Lx, Ly) from the evaluation block size calculating unit 614. The correlation operation parameter calculating unit 616 can be configured to calculate first and second operation parameters Ipx and Ipy with reference to a variation in the first and second sizes (Lx, Ly) of the evaluation blocks. The first operation parameter Ipx indicates how many times the correlation operation should be performed on the X-axis. The second operation parameter Ipy indicates how many times the correlation operation should be performed on the Y-axis. The correlation operation parameter calculating unit 616 can be configured to set the calculated first and second operation parameters Ipx and Ipy in the correlation operation unit 64.

The sorter 65 is configured to receive the correlation value and the motion vector from the correlation operation unit 64. The sorter 65 is configured to receive the weighting factor k from the weighting factor calculating unit 613. The sorter 65 sorts the correlation value, the motion vector, and the weighting factor k and stores them in the second memory 66. The second memory 66 stores the correlation value, the motion vector and the weighting factor at predetermined addresses, the motion vector and the weighting factor having been outputted from the sorter 65. The CPU 2 performs the camera shake correction with reference to the motion vector and the weighting factor k and by using a coefficient related to the appearance frequency.

Even if the optical system has an eccentric distortion, then the evaluation block size is adjusted based on the coordinate position of the evaluation block from the optical center so as to realize a highly accurate correction to the camera shake by using the motion vector.

The term “unit” is used to describe a component, section or part of a hardware and/or software that is constructed and/or programmed to carry out the desired function. Typical examples of the hardware may include, but are not limited to, a device and a circuit.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

What is claimed is:

1. A motion vector detecting apparatus comprising:
a block setting unit that sets a block on a first image, the first image having a distortion caused by an optical system, the block having a size that depends on the distortion; and
a correlation operation unit that calculates a correlation between the block and a second image, the second image differing in capturing-time from the first image, the correlation operation unit obtaining a first motion vector associated with the block with reference to the correlation.

2. The motion vector detecting apparatus according to claim 1, wherein the block setting unit sets the block so that the size of the block is generally uniform after the distortion is corrected.

3. The motion vector detecting apparatus according to claim 1, wherein the block setting unit sets the block at a position selected from a group of positions that have a generally uniform degree of distortion.

4. The motion vector detecting apparatus according to claim 1, further comprising:
a parameter calculating unit that calculates at least one parameter for the block, the at least one parameter being selected from a distance between each of the block and an optical center of the optical system, coordinates of the block, and a weighting factor of the block; and
a detecting unit that detects a second motion vector associated with an entirety of the first image, the detection being performed with reference to the first motion vector and the at least one parameter.

5. The motion vector detecting apparatus according to claim 1, wherein the optical system comprises a co-axial optical system.

6. The motion vector detecting apparatus according to claim 1, wherein the optical system comprises a decentered optical system.

7. A motion vector detecting method comprising:
setting a block on a first image, the first image having a distortion caused by an optical system, the block having a size that depends on the distortion;
calculating a correlation between the block and a second image, the second image differing in capturing-time from the first image; and
obtaining a first motion vector associated with the block with reference to the correlation.

8. The motion vector detecting method according to claim 7, wherein the block is set so that the size of the block is generally uniform after the distortion is corrected.

9. The motion vector detecting method according to claim 7, wherein the block is set at a position on the first image, the position having a generally uniform degree of distortion.

10. The motion vector detecting method according to claim 7, further comprising:
calculating at least one parameter for the block, the at least one parameter being selected from a distance between the block and an optical center of the optical system, coordinates of the block, and a weighting factor of the block; and
detecting a second motion vector associated with an entirety of the first image, the detection being performed with reference to the first motion vector and the at least one parameter.
